(19) United States
(12) Patent Application Publication
(10) Pub. No.: US 2024/0054494 A1
(43) Pub. Date: Feb. 15, 2024

(54) PUFDUF METHODS AND SYSTEMS FOR AUTHENTICATING IDENTITY

(71) Applicant: Sheldon I. Hirshon, Santa Fe, NM (US)

(72) Inventors: Sheldon I. Hirshon, Los Angeles, CA (US); Victor Hughes, Santa Fe, NM (US)

(21) Appl. No.: 17/884,325

(22) Filed: Aug. 9, 2022

(51) Int. Cl. G06Q 20/40; G06F 21/34; G06Q 20/38

(52) U.S. Cl. CPC G06Q 20/4014; G06F 21/34; G06Q 20/3827; G06Q 20/3825; G06Q 2220/00

(57) ABSTRACT

An authentication system and method authenticate identity for secure transmission of data through the authentication system. The authentication system is comprised of one or more sending devices and authentication devices, each of which contains a blackbox logic mechanism to uniquely process dynamic transaction data using a blackbox signature. The authentication device authenticates the sending device for each transaction between them by comparing the dynamic transaction signature sent by the sending device to the a dynamic transaction signature reproduction generated by the authentication device

### TECHNICAL FIELD

The present disclosure is generally directed to identity authentication systems and methods relating to persons, Devices, Digital Assets and Physical Assets.

### BACKGROUND INFORMATION

### Authentication of Identity—Persons and Devices; Security Vulnerabilities

Identification is the act of claiming an identity for a person or a Device, based on factors and/or attributes unique to that person or Device. Authentication is the act of confirming an identity based on the presented factors and/or attributes. Verification of information is achieved when the source of the information is authenticated.

With respect to a person conventional identification and authentication relates to the factors and/or attributes selected from something the person knows, something the person has, and/or something the person is (User Attributes). A user identification is a set of User Attributes, both physical and perceptual, that uniquely defines a specific person (User ID).

With respect to a Device unique factors and/or attributes such as computer address, IMEI number, multi-factor authentication (MFA) or public/private cryptographic key pairs (Device Attributes) are used to identify and authenticate a Device (Device ID).

The authentication of a User ID or a Device ID provides a specific level of identity assurance that the person or Device is most likely the person or Device it is claiming to be.

In modern society, identification and authentication frequently occur remotely using computing devices by which a person or a Device provides a set of static factors and/or attributes specific to the User ID or a Device ID, and a remote server authenticates the claim.

For example, a person who is an employee of a corporation creates a login ID and password (the Employee's Attributes) which is static unless revised, and once revised is again static. The Employee's Attributes are stored on the corporation's database of all employee User IDs, all of which are static. When the employee remotely logs into the corporate network the Employee's Attributes are compared to the corporation's database of all employee User IDs and the employee is permitted access to the network if the Employee's Attributes are confirmed by the corporation's database.

With respect to Devices, over the last 20 years standards and specifications have been developed to address issues relating to mobile security some of which are described above.

However, these identity specific User IDs or Device IDs, and their related User Attributes or Device Attributes, when digitized, can be easily intercepted and cloned over network communications to allow for unauthorized access.

Existing authentication factors built on static User IDs or Device IDs stored in non-volatile memory, have vulnerabilities that may compromise the security of a communication. With the increase in storage and connected transactions related to sensitive information, the consequence of identity misrepresentation can be disastrous. Therefore, the reliance on static User IDs or Device IDs, creates a challenging security problem.

### Software/Firmware—and Hardware-Security Solutions; PUFs

A variety of software/firmware-based security solutions have been proposed for User ID or Device ID authentication protection. Current software/firmware update methods require cryptography, key management, and public/private cryptographic key pairs (PKI) to preserve the confidentiality, integrity and authenticity of the firmware. These techniques are complex, hard to deploy and maintain, costly (i.e., acquisition and maintenance wise) and require sophisticated and expensive key management services. As a result, availability is compromised. Moreover, the encryption key itself needs to be securely stored or transmitted. These security solutions are also prone to tampering and the encrypted channel is susceptible to crypto-analysis and man-in-the-middle attacks.

Hardware-based security techniques build upon software-based techniques and encompass a wide variety of technological innovations: random number generators, encryption key generators, smart cards, biometrics, etc. An existing hardware-based security solution is a Physically Unclonable Function (PUF), which is a physical object embodied in a physical structure that for a given input and conditions provides a physically-defined output (a PUF Response) that serves as a unique identifier, most often for a semiconductor device such as a microprocessor. PUFs are based on the random and complex physical characteristics of each Integrated Circuit (IC). These characteristics occur naturally during semiconductor manufacturing, are inherent in the physical structures of each IC consisting of billions of clustered molecules and/or atoms and are typically derived from the characteristics of the wires and transistors that differ from chip to chip. A PUF is physically unclonable because the random and complex physical characteristics are unique to each IC so it is nearly impossible to manufacture identical ICs. PUFs are also mathematically unclonable because it is very hard to compute an unknown response given the random properties of the random components in a PUF. The combination of physical and mathematical unclonability renders a PUF truly unclonable. Also, PUFs are subject to environmental variations such as temperature, supply voltage and electromagnetic interference, which can affect their performance.

PUFs can be used to create security applications such as random number generators, encryption key generators, and unique physical identifications, and have been used as a means of authenticating individual ICs or to generate cryptographic keys. Today, PUFs are usually implemented in ICs and are typically used in applications with high security requirements.

The Digitally Unclonable Function (DUF) taught in U.S. Pat. No. 10,541,996 and its progeny, incorporated herein by reference, cited the following technical challenges and limitations associated with PUF usage as reasons why the possible security utility provided by PUFs can be difficult to quantify: granular environmental control (e.g., temperature, power flow, pressure) and pure energy source generation (e.g., clean laser frequency or high precision electrical power source), exposure of challenge-response pair at the manufacturing facility as well as minimization of size, weight and power, and cost to manufacture and deploy. Because of these technical challenges, a PUF Response can deviate from the norm, increasing the cost of acquiring consistent and predictable responses. While the positive attributes show some promise for identifying ICs, this technique is not appropriate for non-IC based hardware. In addition, hardware identification based on alpha numeric codes (or any static data) has logical limitations since the uniqueness of the hardware identity is easily compromised when this identity is translated or converted into a digitized form: identity spoofing, replication, and replay attack.

Because a PUF Response deviates from the norm due to intermittent changing degradations that are difficult and costly to anticipate and quantify, the variability of PUFs were typically seen or considered as a vulnerability and unsuitable for methods and systems to authenticate User ID or Device ID for the secure and reliable transmission of data between an Authentication Device and a Sending Device. If the PUF is used for a key in cryptographic algorithms it is necessary that error correction be done to correct any errors caused by the underlying physical processes and reconstruct exactly the same key each time under all operating conditions.

### Digitally Unclonable Function (DUF)

The advent of DUF taught in U.S. Pat. No. 10,541,996 and its progeny, is an attempt to mediate the vulnerability of PUFs by creating a physical device identity with a one-time static capture of “dynamic human input” such as a handwritten signature, or the user entering a symbol, number, or number sequence (Dynamic Human Input) which would then be randomized to create a two-factor authentication based on something you know and something you physically have in your possession. The DUF technology taught in U.S. Pat. No. 10,541,996 is based on Quasi-Physically Unclonable Digital Identification called Q-PUDID. Q-PUDID was developed as a variant to PUF in order to emulate the benefits of PUF while eliminating what were perceived as the negative features of PUF.

The DUF system of U.S. Pat. No. 10,541,996 provides a system that includes a Device comprising device memory, an authenticating system comprising authentication system memory, and a communications network for transmitting data from the Device and to the authenticating system. The Device and authentication system memories contain a device identification assigned to the Device, and the authentication system is configured to authenticate the Device for each transaction by comparing a dynamic login identification created for each transaction in both the Device and the authenticating system.

In a divisional application dated May 14, 2020, Pub. No. US 2020/0153819 A1, of U.S. Pat. No. 10,541,996, a method is disclosed that includes the following steps: creating a Device identification associated with a Device by processing a user generated signature with a generated random number, storing the device identification on the Device and on a authentication system, initiating a communication by entering a login into the Device, processing the login, the device identification and transaction information on the Device to create a dynamic identification, processing the login, device identification and transaction information on the authentication system to create a confirmation dynamic identification, and comparing the dynamic identification and confirmation dynamic identification on the authenticating system to authenticate a user.

DUF technology offers these cybersecurity advantages: (1) Cyber identity is anchored in a unique, physically unclonable device. Unlike password or biometrics escrowing, with the DUF technology, there is no possibility of a mass breach. Criminals must not only steal a user's password/biometrics but must also steal the user's phone or computer through which a user's ephemeral identity must flow. (2) Because DUF identity is tied to having two factors, what you know and what you have, compromise of one does not compromise the other. The DUF technology renders most of the existing cyber threats (ie., identity fraud, APT, remote attacks) irrelevant. Virtual identity is intimately linked to attributes of physical identity. (3) The DUF technology eliminates reliance on User ID or Device ID that remains static and does not use encryption to keep confidential the static User ID or Device ID. The DUF technology is dynamic in that it captures the physical integrity of a tamper resistant device to modify the static User ID or Device ID so that the User ID or Device ID is never exposed during transmission.

The teachings of U.S. Pat. No. 10,541,996 implicate these fundamental propositions:
a. A PUF Response is inherently variable and therefore unsuitable for methods and systems to authenticate User ID or Device ID or for the secure and reliable transmission of data between an Authentication Device and a remote Sending Device;
b. The solution taught by U.S. Pat. No. 10,541,996 requires Dynamic Human Input in both the creation of the Blackbox Signature and the creation of the Dynamic Transaction Data;
c. As a result, the creation of the Blackbox Signature and the Dynamic Transaction Data described in U.S. Pat. No. 10,541,996 is external to the Sending Device;
d. While Dynamic Human Input may be advantageous for one-off or single verification transactions, it is not scalable as Dynamic Human Input is impractical for a voluminous number of transactions; and
e. The DUF protocol described in U.S. Pat. No. 10,541,996 is a one-direction communication from the Sending Device to the Authentication Device.

U.S. Pat. No. 10,541,996 poses the dilemma “Are there alternatives to PUF where we can avoid making nano-scale measurements while retaining the DUF-like abilities; data flows-in (sic) and interacts with medium where output data is modified/changed uniquely to that device?”

Exemplary embodiments of the present disclosure answer this question by providing a new and improved PUFDUF Protocol.

### SUMMARY

The present disclosure is generally directed to identity authentication systems and methods, and more particularly to authentication systems and methods that authenticate identity for the secure and reliable transmission of data through an authentication system comprised of one or more Sending Devices and Authentication Devices, each of which contains a Blackbox logic Mechanism to uniquely process Dynamic Transaction Data using a Blackbox Signature so that the Authentication Device authenticates the Sending Device for each transaction between them by comparing the Dynamic Transaction Signature sent by the Sending Device to the Dynamic Transaction Signature Reproduction generated by the Authentication Device.

If the Dynamic Transaction Signature Reproduction generated by the Authentication Device matches the Dynamic Transaction Signature received from the Sending Device, the Authentication Device acknowledges the authenticity of the Sending Device and verifies the Dynamic Transaction Data with high assurance and executes or responds to the Dynamic Transaction Data it received. If the Dynamic Transaction Signature Reproduction does not match the Dynamic Transaction Signature, the Authentication Device will not recognize the Sending Device and will reject or ignore the Dynamic Transaction Data as being unverified.

The PUFDUF Protocol (as defined herein) in a single transmission provides high assurance of Device authenticity and message integrity verification. The PUFDUF Protocol eliminates the multiple steps employed by conventional systems and methods such as public/private encryption keys (PKI) and also eliminates the complexity and expense of deploying and managing PKI.

Additionally, the present disclosure is directed to systems and methods that authenticate identity for the secure and reliable transmission of information through the PUFDUF Protocol taught in this disclosure. The PUFDUF Protocol envisions authentication systems and methods comprised of one or more Authentication Devices and one or more Sending Devices each of which contains an embedded Blackbox Mechanism.

Each Blackbox Mechanism that resides in each Authentication Device and Sending Device shares a tamper resistant mechanism (TRM) such as, but not limited to, a smartcard chip, an embedded hardware security module or a trusted platform module, which contains a hardware-based secure firmware necessary to implement the cybersecurity systems, methods and processes described in this disclosure.

The hardware-based secure firmware is called the Blackbox Signature which is derived from a PUF Response derived from (i) the unique frequency generated by the volatile chip-specific signature at runtime of an integrated circuit (IC) in a Sending Device (a Single PUF Response), or (ii) the combination of multiple PUF Responses from a single IC or multiple ICs in the Sending Device (Multiple PUF Response), or (iii) adding a random number generator function to a Single PUF Response or Multiple PUF Responses, or (iv) a Device Fingerprint (information collected about the software and hardware of a Device for the purpose of identification usually assimilated into a brief identifier using a fingerprinting algorithm).

One exemplary embodiment of the PUFDUF Protocol envisions an entity with an escrow of Blackbox Signatures stored in a highly secure facility. Other exemplary embodiments of the PUFDUF Protocol envisions an entity with an escrow of Blackbox Signatures that are created “on the fly” or in real time.

By using a PUF Response to generate a sufficiently random Blackbox Signature that is embedded in the Blackbox Mechanism, the PUFDUF Protocol utilizes the previously seen disadvantages or vulnerabilities of a PUF Response—namely, the random and variable nature of a PUF Response at the runtime—to create a highly secure and assured communication system and method.

Depending on the nature of a transaction, a Device may be an Authentication Device or a Sending Device, and there may be multiple Authentication Devices or Sending Devices.

The PUFDUF Protocol is an inexpensive and efficient plug-in module that uses a convenient, easy-to-deploy, simple-to-maintain, hardware-protected hashing mechanism that provides authenticity and integrity in real-time in one simple step. Current communication methods require cryptography, key management, and PKI to preserve the confidentiality, integrity, and authenticity of the message—thereby exposing additional attack vectors. In contrast, the PUFDUF Protocol is an improvement defined by DUF technology enhanced by a PUF Response to bypass these costly and complex security solutions. With the PUFDUF Protocol there is no need to connect with code-signing certificate authority or query the blackbox escrow, build and manage encryption keys, or establish a secure session.

A Device includes computer components which may include processor(s), memory, hardware, software, and firmware to execute instructions and store information.

A Sending Device is a Device that transmits the Dynamic Transaction Data and the Dynamic Transaction Signature to the Authentication Device.

An Authentication Device is a Device that receives from the Sending Device the Dynamic Transaction Signature and the Dynamic Transaction Data which is processed by the Authentication Device to create a Dynamic Transaction Signature Reproduction.

The teachings in this disclosure are based on these fundamental propositions:
a. Because a PUF Response is inherently variable it is perfectly suitable for methods and systems to authenticate User ID or Device ID and for the secure and reliable transmission of data between an Authentication Device and a remote Sending Device;
b. In contrast to U.S. Pat. No. 10,541,996, no Dynamic Human Input is needed to create the Blackbox Signature or conduct a transaction;
c. By eliminating Dynamic Human Input the number of possible registrations and transactions are scalable;
d. In contrast to the external signature generation described in U.S. Pat. No. 10,541,996, the Blackbox Signature is internally generated; and
e. The PUFDUF Protocol described herein is a two-direction communication system which is essential for certain embodiments as described below. In effect, depending on the nature of the transaction, any Device can be either the Sending Device or the Authentication Device.

According to one aspect, an exemplary embodiment of the present disclosure may provide a system comprising: a Device comprising device memory; an authenticating system comprising authentication system memory; a Device Identification (Device ID) registered at both the device and the authenticating system; and a communications network for transmitting data between the device and the authenticating system; wherein the Device and authentication system memories contain the Device ID assigned to the Device; wherein the authenticating system authenticates the Device for each transaction between the Device and the authenticating system by comparing a dynamic Device ID created for each transaction in both the Device and the authenticating system; and wherein the dynamic Device ID is created at the Device and authenticating system by combining the Device ID with a login and transaction information to create process data that is processed by a hash algorithm; and wherein the authentication system memory contains the Device ID prior to authentication; and wherein the device identification is created from processing a PUF of an integrated circuit (IC) in the Device and one of (i) a random number; (ii) a second PUF of a second circuit in the device; and (iii) the PUF alone, the same Device ID is used to create the dynamic Device ID for each transaction without the need for a human-based authenticator. This exemplary embodiment or another exemplary embodiment may further provide wherein the device is one of a plurality of Devices that are authenticated at a single time without input of the a human-based authenticator. This exemplary embodiment or another exemplary embodiment may further provide wherein the Device is a vehicle from a plurality of vehicles receiving a firmware-over-the-air (FOTA) update from a manufacturer of the Device, and the integrated circuit generating the PUF identifier is located on the vehicle. This exemplary embodiment or another exemplary embodiment may further provide wherein the device is selected from a group consisting of smart phones, computer laptops, computer tablets, point of sale Devices and electronic control units. This exemplary embodiment or another exemplary embodiment may further provide wherein the device is an unmanned vehicle control unit and the authenticating system is an unmanned vehicle. This exemplary embodiment or another exemplary embodiment may further provide wherein the device memory resides on a platform selected from a group consisting of a trusted platform module, SmartCard, and SmartChip. This exemplary embodiment or another exemplary embodiment may further provide wherein the system is selected from a group consisting of financial institutions, commercial retailers, military systems, automobile electronics system, medical institutions, government institutions, cloud storage systems, critical infrastructure systems and security systems. This exemplary embodiment or another exemplary embodiment may further provide wherein the military system is an unmanned vehicle control system. This exemplary embodiment or another exemplary embodiment may further provide wherein the login is selected from a group consisting of a username, password and personal identification number. This exemplary embodiment or another exemplary embodiment may further provide wherein the transaction information is selected from a group consisting of time, transaction cost, command, request and location.

In another aspect, an exemplary embodiment of the present disclosure may provide a method comprising: creating a Device ID associated with a Device by processing a PUF of a circuit in the Device with a generated random number; storing the Device ID on the Device and in an authentication system; initiating a communication by entering a login into the device; processing the login, the Device ID and transaction information on the device to create a dynamic identification; processing the login, Device ID and transaction information on the authentication system to create a confirmation dynamic identification; and comparing the dynamic identification and confirmation dynamic identification on the authenticating system to authenticate the device simultaneous to an identical process occurring on a second Device needing to be authenticated by the authentication system at the same time as the Device without any human-based authenticators. This exemplary embodiment or another exemplary embodiment may further provide wherein the Device is selected from a group consisting of smart phones, computer laptops, computer tablets, point of sale devices, unmanned vehicle control units, and electronic control units. This exemplary embodiment or another exemplary embodiment may further provide wherein the device is an unmanned vehicle control unit and the authenticating system is an unmanned vehicle. This exemplary embodiment or another exemplary embodiment may further provide wherein storing the Device ID on the Device comprises storing the device identification on a platform selected from a group consisting of a trusted platform module, SmartCard, and SmartChip. This exemplary embodiment or another exemplary embodiment may further provide wherein the authentication system is a component of a system selected from a group consisting of financial institutions, commercial retailers, military systems, automobile electronics system, medical institutions, government institutions, cloud storage systems, critical infrastructure systems and security systems. This exemplary embodiment or another exemplary embodiment may further provide wherein the authentication system is an unmanned vehicle control system. This exemplary embodiment or another exemplary embodiment may further provide wherein the login is selected from a group consisting of a username, password and personal identification number. This exemplary embodiment or another exemplary embodiment may further provide wherein the transaction information is selected from a group consisting of time, transaction cost, command, request and location.

Some of these embodiments are possible because the PUFDUF Protocol is scalable as the Blackbox Signature is created from an internally generated random PUF Response rather than the external Dynamic Human Input of the DUF technology of U.S. Pat. No. 10,541,996. Therefore, the process to create the Blackbox Signature can be automated.

Further, as the creation of the Blackbox Signature can be automated without any Dynamic Human Input, and then subjected to XOR message digest function/hash algorithm processes, it is immutable, unknown to anyone, unknowable by anyone, cannot be reverse engineered and is unspoofable. Therefore, each networked Device, whether acting as a Sending Device or an Authentication Device, receives a secure transmission from a trusted and secure source.

In accordance with an exemplary aspect of the present disclosure, an embodiment may provide a system and method, comprising: a Sending Device; an authenticating system comprising an Authentication Device; a Blackbox Mechanism residing in both the Sending Device and the Authentication Device in which the same Blackbox Signature is simultaneously registered and stored in memory; and a communications network for transmitting data between the Sending Device and the Authentication Device; wherein the Authentication Device authenticates the Sending Device for each transaction between them by comparing the Dynamic Transaction Signature sent by the Sending Device to the Dynamic Transaction Signature Reproduction generated by the Authentication Device of the authenticating system; and wherein the Dynamic Transaction Signature is created by the Sending Device and the Dynamic Transaction Signature Reproduction is created by the Authentication Device by combining the Blackbox Signature with Dynamic Transaction Data which is subjected to XOR message digest function/hash algorithm processes, and wherein the Blackbox Signature is created from processing a PUF Response without the need for a human-based authenticator.

### BRIEF DESCRIPTION OF THE DRAWINGS

FIG. 1 is a diagrammatic flow chart depicting an exemplary embodiment of an authentication protocol according to one aspect of the present disclosure.

FIG. 2 is a diagrammatic flow chart depicting another exemplary embodiment of an authentication protocol according to another aspect of the present disclosure.

FIG. 3 is a diagrammatic flow chart depicting another exemplary embodiment of an authentication protocol according to another aspect of the present disclosure.

FIG. 4 is a diagrammatic flow chart depicting another exemplary embodiment of an authentication protocol according to another aspect of the present disclosure.

FIG. 5 is a diagrammatic flow chart depicting another exemplary embodiment of an authentication protocol according to another aspect of the present disclosure.

FIG. 6 is a diagrammatic flow chart depicting another exemplary embodiment of an authentication protocol according to another aspect of the present disclosure.

FIG. 7 is a diagrammatic flow chart depicting another exemplary embodiment of an authentication protocol according to another aspect of the present disclosure that specifically eliminates the need for tamper resistant hardware and provides a protocol that can be fully embodied as software or other hardware that is not tamper resistant.

Wherever possible, the same reference numbers will be used throughout the drawings to represent the same part.

### DETAILED DESCRIPTION

The present disclosure will now be described more fully with reference to the accompanying figures, in which preferred, but exemplary, embodiments of the disclosure are shown. This disclosure may, however, be embodied in many different forms and should not be construed as limited to the embodiments set forth herein; rather, these embodiments are provided so that this disclosure will be thorough and complete and will fully convey the scope of the invention to those skilled in the art.

The PUFDUF Protocol with an Improved Static Blackbox Signature

According to embodiments of the present disclosure, systems and methods are disclosed in which a physical device (the Blackbox Mechanism) holds an identity (the Blackbox Signature which is based on a PUF Response) that modifies Dynamic Transaction Data for the secure and reliable transmission of data in an authentication system comprised of one or more Sending Devices and Authentication Devices, referred to herein as the PUFDUF Protocol.

The following is a exemplary description of the PUFDUF Protocol.
a. The Blackbox Mechanism is a TRM embedded in each Sending Device and each Authentication Device in the authentication system.
b. The Blackbox Signature is derived from a PUF Response and resides in the memory of each Blackbox Mechanism in the authentication system.
c. The PUFDUF Protocol is initiated on the Sending Device when it receives Dynamic Transaction Data comprised of a Transaction Timestamp combined with either (i) User Information or Transaction Data or (ii) User Information and Transaction Data.
   i. A Transaction Timestamp—dynamic input which is the non-repeatable timestamp information (Day/Month/Year/Time) associated with a particular and discrete transaction.
   ii. A User Information—static input, both physical and perceptual, which includes but is not limited to: (i) user login information, (ii) username, (iii) password, (iv) personal identification number (PIN), (v) one-time-pad, (vi) yin-number, (vii) serial-number, (viii) biometric information, (ix) personally identifying information (PII), (x) a digital fingerprint, or (xi) any combination thereof;
   iii. Transaction Data—dynamic input which includes but is not limited to: (i) purchase, deposit, withdrawal, and/or account balance information, (ii) physical location identifying information, (iii) product identifying information, (iv) command and control information, (v) software/firmware information, or (iv) any combination thereof specific to any particular and discrete transaction.
d. In the Blackbox Mechanism the Dynamic Transaction Data is hashed using a message digest function such as SHA512 creating Hashed Dynamic Transaction Data.
e. In the Blackbox Mechanism the Blackbox Signature modifies the Hashed Dynamic Transaction Data by performing an XOR operation to create Processed Dynamic Transaction Data.
f. In the Blackbox Mechanism the Processed Dynamic Transaction Data is hashed using SHA512 creating the Dynamic Transaction Signature.
g. The Sending Device transmits The Dynamic Transaction Data and the Dynamic Transaction Signature to the Authentication Device.
h. Using its Blackbox Mechanism the Authentication Device generates a Dynamic Transaction Signature Reproduction by processing the Dynamic Transaction Data received from the Sending Device using the same process the Sending Device used to generate the Dynamic Transaction Signature.
i. If the Dynamic Transaction Signature Reproduction generated by the Authentication Device matches the Dynamic Transaction Signature received from the Sending Device, the Authentication Device acknowledges the authenticity of the Sending Device and executes or responds to the Dynamic Transaction Data it received.
j. If the Dynamic Transaction Signature Reproduction does not match the Dynamic Transaction Signature received from the Sending Device, the Authentication Device will not recognize the Sending Device and will reject or ignore the Dynamic Transaction Data it received and issue a termination report.

The Blackbox Signature may be communicated from the Sending Device to be registered on the Authentication Device over wired or wireless secure communications. The secure communications may include protocols, such as, but not limited to secure socket layer (SSL) and transport layer security (TLS). The Sending Device may or may not be in communication with the Authentication Device at the time of creation of the Blackbox Signature. Registration may also be accomplished using physically binding process at a secure facility. It is important to note that for the secure network to remain secure, the Blackbox Signature residing in both the Sending Device and the Authentication Device must remain secure or confidential such that no access to the Blackbox Signature is permitted even by system and/or identity owners.

As noted, the PUF Response is totally variable and random until the runtime registration at which time the Blackbox Signature is created. It is important to note that while the Blackbox Signature then becomes static as used in the PUFDUF Protocol it is never separately revealed or transmitted as it becomes part of the Dynamic Transaction Data.

### Security—Active Authentication and High Assurance

Active Authentication (also commonly referred to as Continuous Authentication) is a persistent identity authentication process, whereby an identity authentication protocol establishes and confirms the identity of the person/people, Device, Digital Asset(s) and Physical Asset(s), involved in one or more data transmissions, during each discrete data transmission.

High Assurance refers to data transmissions received by an Authentication Device that are demonstrably accurate, sent from an authorized person or Device or related to Digital Assets or Physical Assets, and received, interpreted, and acted upon appropriately in accordance with the sender's intent, all with a high degree of confidence.

The PUFDUF Protocol provides active authentication and high assurance as it provides the following security attributes: Confidentiality—the transmission may be sent in either open plain language or with encryption if needed; Integrity—the transmission will remain intact; Availability—the transmission will be executable in the micro-second range; and Authenticity—the transmission will have proper identity verification every single time.

Placing the Blackbox Signature in the memory of each Blackbox Mechanism embedded in a Sending Device or Authentication Device creates two or more separated but identical communication endpoints so that the digital identities of these Devices are not transmitted and therefore not exposed to cryptoanalysis in transit. This feature of the PUFDUF Protocol together with the XOR and hash algorithm processes make the PUFDUF Protocol authentication methods highly resistant to cloning and simulation attacks.

The Blackbox Signature:
a. is totally random as the PUF Response is generated at runtime and until then the PUF Response is random;
   i. at runtime the PUF Response becomes static and resides in the memory of the Blackbox Mechanism in each of the Sending Device and the Authentication Device;
b. is generated internally without any external Dynamic Human Input;
c. is immutable, unknown to anyone, unknowable by anyone and unspoofable; and
d. multiple Blackbox Signatures can be created on the same Device (similar to the interstitial channels in wireless telecommunication systems).

Any potential attacker who gains physical access to either the Sending Device or the Authentication Device will be unable to recreate the Blackbox Signature because even in the unlikely event the attacker can identify the element of the IC that yielded the PUF Response that generated the Blackbox Signature, the variability of the PUF Response means the attacker could not reproduce the PUF Response that generated the Blackbox Signature.

Further, any potential attacker cannot reverse engineer the PUFDUF Protocol because the Blackbox Signature is generated randomly, internally and dynamically and is unknown, unknowable and unspoofable. Further, it is processed through several SHA512 message digest functions and then submitted to an XOR operation. This process produces scrambled data that cannot be read or extracted without a lot of time and a scanning electron microscope. The use of the PUF Response to create the Blackbox Signature is a significant security improvement by replacing the Dynamic Human Input required by the DUF system with a random hardware identity that is physically unknowable and unclonable at any given moment.

Additionally, by using attributes of the PUFDUF Protocol present in this disclosure an almost unlimited number of Blackbox Signatures can be generated on the Sending Device and the Authentication Device. This means a remote Device such as a smartphone can have a separate Blackbox Signature for each account: the owner's bank account, the owner's car, the owner's home security system, etc.

PUFDUF Protocol without Random Generator Function or TRM

It should be noted that a Single PUF Response or a Multiple PUF Response is sufficiently random to provide high assurance to enable the extremely secure and reliable transmission of data and execution of legitimate authorized operations between and by Devices without adding a random number generator function. Therefore, the PUFDUF Protocol could eliminate the random number generator requirement without sacrificing the Blackbox Signature feature, and thereby, eliminate a significant barrier to implementation without compromising functionality. This allows the implementation of new secure Device registration and Blackbox Signature creation protocols. It will also allow the implementation of new secure multi-asset system communication protocols. Further it may therefore eliminate or reduce the need for TRMs.

PUFDUF Protocol without Static Blackbox Signature

Another exemplary embodiment provides a PUFDUF Protocol where there is no need to store static data (as was the case with previous DUF systems, such as those taught by U.S. Pat. No. 10,541,996) on the Authentication Device.

A version of the PUFDUF Protocol would activate the Sending Device to develop a new PUF Response which would become part of the Dynamic Transaction Data sent to the Authentication Device. The new PUF Response would replace the prior PUF Response and reset the Blackbox Signature. The Authentication Device would unscramble the Dynamic Transaction Data to find the new PUF Response and then use it. This could be done as often as necessary, or even on a regular schedule. While the Blackbox Signature is static for a time, it is always conditional as it could be automatically updated.

In this embodiment the PUFDUF Protocol will make it impossible for anyone to physically scrape the Blackbox Signature from either a Sending Device or an Authentication Device because the Blackbox Signature is not stored on the Device.

### PUFDUF Protocol—Remote Blackbox Signature Registration and Communication

Using the above version of the PUFDUF Protocol a remote Device could be activated to develop a PUF Response. This has two advantages in addition to the discussion above. First, the remote does not need to be in proximity to the Authentication Device for the PUFDUF Protocol to be installed. Second, remote devices could be instructed to exchange their Blackbox Signatures which could be important for military C&C and for vehicle sensor integration.

PUFDUF Protocol without a Blackbox Signature

Aspects of the present disclosure enable using attributes of the PUFDUF Protocol on the remote Device to generate a Blackbox Signature only when needed so that the Blackbox Signature is never stored on the remote device. This means it can never be hacked or discovered even if the remote Device is stolen.

### PUFDUF Protocol—2—Way Communication

At the time of Blackbox Signature registration the same PUF Response is embedded in the Sending Device and the Authentication Device and used to process Dynamic Transaction Data. In this way, each Device has the ability to authenticate the other. The result is an authentication system and method that allows for Devices to securely communicate with each other; i.e., every Device can be a Sending Device or an Authentication Device depending on the direction of the communication.

### Exemplary Embodiments

In some of the embodiments taught in this disclosure one or several of the varieties of the PUFDUF Protocol may be applicable. The exemplary embodiments discussed below are not exclusive and meant to demonstrate several, but not all, of the potential applications of the PUFDUF Protocol. Digital Assets and Physical Assets separately as there are many potential uses of the PUFDUF Protocol in those area.

Exemplary embodiments of the PUFDUF Protocol include, but are not limited to, the following:
a. As a general observation applicable to all exemplary embodiments, the SHA512 and the XOR message digest function/hash algorithm feature of the Blackbox Mechanism provides high security by removing a reversible connection between the Dynamic Transaction Data and the Blackbox Signature. Therefore, where appropriate, an embodiment may allow communication between Devices in the clear (unsecure) as the Dynamic Transaction Data is protected by the Blackbox Signature that cannot be reused or replayed.
b. In an embodiment of the disclosure involving a command and control use the ground station would be the Sending Device transmitting an order to a remote drone or to a fleet of remote drones each of which would be the Authentication Device. Each drone would respond to the ground station so that the drone(s) would then be the Sending Device(s) and the ground station would be the Authentication Device. The Drone(s) may have one or more Blackbox Signatures registered in its memory to allow operation by or hand-offs by one or more command units. It would also allow communications among the fleet of drones.
c. In an embodiment of the disclosure involving an automobile manufacturer that wants to issue a large-scale mass wireless update to a plurality of deployed vehicles, such as a firmware-over-the-air (FOTA) update, to a fleet of electric vehicles, autonomous driving vehicles or connected vehicles, the manufacturer would act as the base and be the Sending Device and the vehicle would be the Authentication Device. Each vehicle would respond to the base so that the vehicle would then be the Sending Device and the base would be the Authentication Device.
d. Today's vehicles have up to 150 electronic control units (ECUs) and about 100 million lines of code creating a digital car ecosystem that collects log events and feeds the vehicle's security operations center (SOC), and the manufacturer, with information to detect anomalies and other adverse events such as an unlawful hacking. Each ECU has its own unique and random PUF Response at any given point in time. Any of these ICs can be selected to create a Blackbox Signature at a given time as the unique and random identifier that is used in PUFDUF Protocol of the present disclosure. The Blackbox Signature can be based on either a Single PUF Response or a Multiple PUF Response. In addition, sensor ECUs communicate with other ECUs in the vehicle and could be influenced through sensor signal manipulation. In an embodiment of the disclosure the PUFDUF Protocol could be embedded in each ECU and the SOC so that only authenticated communications would be accepted. In this setting, each ECU and the SOC would act as either the Sending Device or the Authentication Device depending on the direction of the transaction. And, each ECU could communicate with another ECU creating a secure digital communication network within the vehicle.
e. In an embodiment of the disclosure involving an industrial control setting, such as a water treatment plant, an electric energy grid or other utility, the control center would be the Sending Device and the remote control valves would be the Authentication Devices. Similar to the vehicle digital ecosystem, the remote control valves may transmit to the control center or to other remote valves. In this setting, each remote control valve and the control center would act as either the Sending Device or the Authentication Device depending on the direction of the transaction.
f. In an embodiment of the disclosure involving a credit card transaction, the user's credit card or smart phone would be the Sending Device and the credit card company authenticating system would be the Authentication Device.
g. In an embodiment of the disclosure involving a financial institution, the user's smart phone or computer tablet would be the Sending Device and the financial institution's authenticating system would be the Authentication Device.
h. In an embodiment of the disclosure involving a retailer, the customer's smart phone or computer tablet would be the Sending Device and the retailer's a point of sales device would be the Authentication Device.
i. In an embodiment of the disclosure involving protection of networks, the PUFDUF Protocol can be used to protect hardware initialization during the booting process (power-on startup), and to provide runtime systems for operating systems and programs. This would protect uninfected systems and could also be used in compromised networks by authenticating the various firmware and hardware systems. For example this would be a satisfactory response to the Solar Winds and Colonial Pipeline hacks. Namely, the PUFDUF Protocol could prevent operating systems hacks and, further, to allow compromised systems to operate despite the security invasion
j. Other exemplary embodiments of the disclosure may involve or relate to, medical institutions; government institutions; civil facilities; cloud storage systems; hospital drug dispensing systems; registered and unregistered platforms in both civil and defense applications, particularly in identity, friend or foe (IFF) applications; information management and security, including software and/or hardware products such as file sharing protocols; identity management and security (e.g. authenticity verification and networks of trust applications), of people (e.g. commercial and enterprise products), physical assets (e.g. edge devices, smart home devices, devices used/owned by enterprises), and digital assets (tokens, firmware/software, content, etc.); telecommunications systems; supply-chain management systems; IoT device/network systems; cyber physical systems; encryption systems; and security software/hardware systems.

### Digital Assets and Digital Rights Management

Digital Assets and Digital Rights Management are two use cases with significant need for the assured communications provided by the PUFDUF Protocol.

A digital asset is anything that exists in binary data which is self-contained, uniquely identifiable, and has a value or ability to use (Digital Asset). When the term originated in the mid-1990s, Digital Assets were items such as videos, images, audio, and documentation. Since then, technological advances have given the term new life.

Blockchain technology didn't change the meaning of Digital Assets, but it did make the term cover a broader range of items. Importantly, many Digital Assets have the potential to disrupt entire industries and even the global market moving forward. Today, inventions such as cryptocurrencies are part of the Digital Asset revolution.

A blockchain is a giant network of computers that simultaneously verifies data on a digital ledger. This network enables data to be stored, unaltered, and verified via code.

The transparency of the blockchain technology is unprecedented. This technology allows people, for the first time in history, to unequivocally prove certain aspects of a Digital Asset, such as ownership, authenticity, transaction history, and location without the need to involve third-parties.

The ability to erase the middleman comes from blockchain's programmability. Blockchain Digital Assets utilize rules that are built into the code of the network, and/or, the token itself. Importantly, these standards receive continuous auditing via the network. This coding has advanced significantly since the emergence of blockchain technology. Today, advanced integrated protocols known as “smart contracts” are at the core of the Digital Asset revolution.

Token taxonomy is the classification of digital assets on the blockchain. Importantly, token taxonomy plays a prominent role in the markets moving forward because the classification of a Digital Asset determines its issuance and trading capabilities.

The three main types of token classifications are:
a. Cryptocurrencies—This type of Digital Asset includes traditional cryptocurrencies such as Bitcoin and Litecoin. These tokens usually function as a form of digital cash. As such, they are decentralized and offer a true peer-to-peer exchange protocol.
b. Utility Token—This type of digital asset operates within the ecosystem of a platform to derive value and complete various tasks. Importantly, it doesn't represent any direct ownership or investment in a firm.
c. Security Token—Security tokens are any token that by design represents a share of ownership or an investment in a company. Usually, these tokens are found in highly-regulated markets such as real estate, securities, or stock markets.

Today, Digital Asset are everywhere. Every single currency, asset, supply chain, and even reward point has the potential for tokenization. As such, the term digital asset will continue to encompass a growing number of items.

Non-fungible tokens (NFTs) are a form of Digital Asset that represents real-world objects like art, music, in-game items and videos. They are bought and sold online, frequently with cryptocurrency and are generally encoded with the same underlying software as cryptocurrency. NFTs are generally one of a kind, or at least one of a very limited run, and have unique identifying codes.

Another form of Digital Assets is electronic media from video games to streaming video. Digital media companies seek to protect their content from copyright infringement and unauthorized use through various mechanisms generally called Digital Rights Management.

Until recently, blockchains were seen as an “unhackable” technology. That is no longer the case. Hackers have gotten away with nearly $2 billion worth of cryptocurrency since 2017 by attacking the unique vulnerabilities of blockchains. Information or currency on a blockchain is not more secure than any other form of storage. In one recent attack, a hacker was able to gain control over a network and rewrite transaction history. The same qualities that make blockchain technology so secure may also be the source of several unique vulnerabilities similar to that of any other banking system.

The PUFDUF Protocol provides the authentication of identity and integrity of content which is the essential component and paramount concern of the Digital Asset revolution, whether cryptocurrencies or NFTs.

### Physical Assets

Physical Assets, also known as tangible assets, are items of value that have a real material presence and include things like property, plant, and equipment as well as inventories. Physical Assets also include non-reproducible assets such as a work of art or a weapon. Various embodiments of the PUFDUF Protocol can provide needed protection as mentioned above. Here we focus on critical infrastructure as it is among the most serious security challenges as illustrated by the hacks of the Colonial Pipeline and the Oldsmar, Florida, water treatment plant.

There are several PUFDUF Protocol embodiments that would protect against these infiltrations. A version of the command and control embodiment is an example. In this embodiment the PUFDUF Protocol would be deployed at the central command center and to each of the remote sensors or control valves. By using a hardware-based and related firmware application shared by the central command center and the fielded equipment no order or direction would be effective unless it was authenticated as sent by an authorized sender.

The following descriptions relating to the depicted figures illustrate processes for a Sending Device securely communicating with a Authentication Device as described above and according to an embodiment of the disclosure. The process at any step may include analogue to digital conversion when the input data (login and transactional data) is an analog signal.

The Figures depict a system according to exemplary embodiments of the disclosure. An exemplary system includes an authentication device, a sending device, and a communication network communicatively coupling the authentication device to the sending device. The authentication device is a component of a service system or device to which the user desires secure communications. The authentication device includes computer components, which may include logic, processor(s), memory, hardware, software, and firmware to execute instructions and store information for the secure communications. The authentication device also includes a communications module for communicating with the sending device and with other components associated with the authentication device and service system or device. For example, in a banking application, the authentication device needs to communicate with other service systems, such as bank units, in order to process communication instructions received from and transmitted to the sending device. It is important to note that the blackbox signature residing in the authentication device should not be exposed or accessible by the authentication system administrator so as to limit access to the blackbox signature.

The sending device is used to securely communicate the identity of the sending device so as permit data to be securely exchanged between the sending device and the authentication device. For example, the sending device may be, but is not limited to a smart phone or other computer device. The computer device may be, but is not limited to smartphones, computer tablets, laptops, desktops, point of sale systems or devices and programming and test devices.

The secure communications network may be a wired network, wireless network, or combination thereof. The secure communications network includes hardware, software, and firmware to execute instructions to securely transmit data via protocols, such as, but not limited to secure socket layer (SSL) and transport layer security (TLS). At least a portion of the network resides in the sending device and authentication device as discussed below. The secure communications network may include external components (not shown), such as repeaters, boosters that are known components of network communications. As discussed above, after the registration of the blackbox signature with the sending device and the authentication device, communications may be made in the clear as the data is protected by the Blackbox Signature. It should be understood, sending device and authentication device may contain the blackbox signature of multiple devices.

The sending devices discussed herein may include a user interface, a processor and communications system. In one exemplary embodiment, the sending device is a smart phone. The user interface allows a user to enter data. In this exemplary embodiment, the user interface is a touch screen. In other embodiments, the user interface may be, but is not limited to touch screens, biometric readers, microphones, cameras and keypads.

The processor may include one or more of hardware, software, firmware and memory capable of creating and storing the blackbox signature, processing communications with the message/hash engine, and executing instructions at least in performing the secure communications. The processor may include an analog to digital converter. In an embodiment, the blackbox signature is stored in a Tamper Resistant Mechanism (TRM), which may be incorporated into the sending device and/or processor or may reside an another component.

The communications system transmits communications over the secure communications network and includes a secure architecture such as, but not limited to secure socket layer (SSL) and transport layer security (TLS).

In another embodiment the authentication device may be a combination of two or more devices and/or components. The two or more components may each perform specific functions or functions that overlap. In an embodiment, the authentication device may include an insertable/removable module that contains the stored blackbox signature. The module may be, but is not limited to a TRM. For example, the module may be a TRM containing the Blackbox Signature that is inserted into a laptop.

Authentication System(s) with Reference to the Figures.

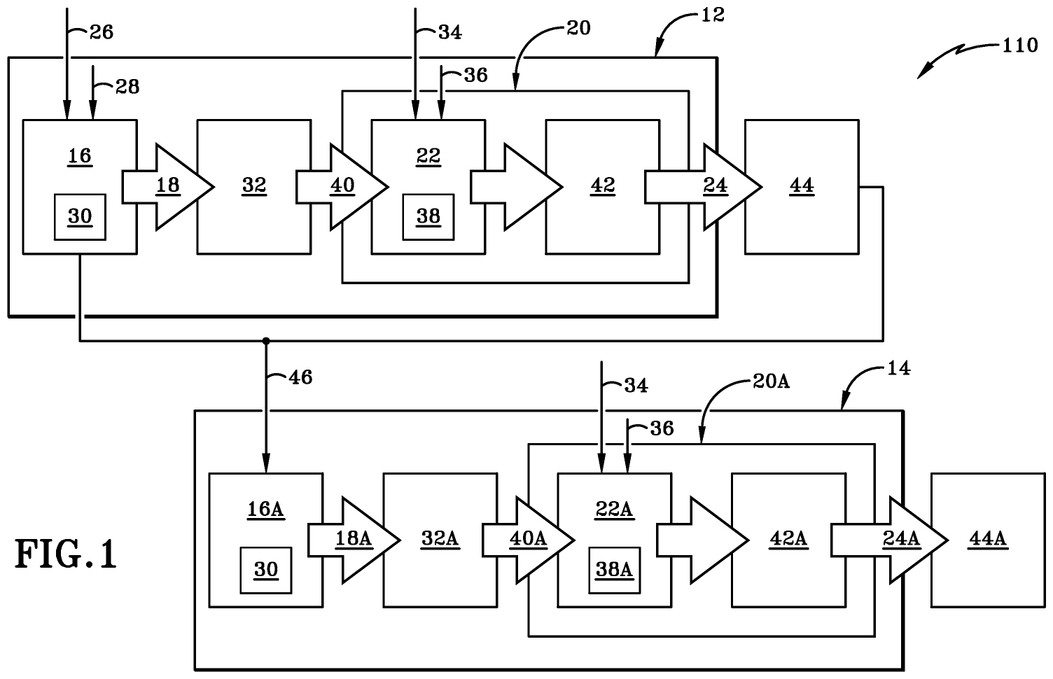

FIG. 1 depicts an authentication system in accordance with an exemplary aspect of the present disclosure. Authentication system 110 includes a sending device 12 and an authentication device 14. Sending device 12 includes input logic 16, a first hashing function or algorithm 18, and a tamper-resistant hardware 20 (TRM 20). TRM 20 includes TRM input logic 22 and the TRM 20 additionally includes a second hashing function 24.

Input logic 16 may accept inputs from an external input 26 and an internal input 28 or optionally one of the two. The input logic 16 receives the external input 26 and the internal input 28 to generate dynamic transaction data 30. The external input 26 may be a user input in the form of a user id or transaction data. The internal input 28 can be a transaction's time stamp. Collectively, the user ID and/or the transaction data from external input 26 are combined with the transaction time stamp as the internal input 28 to create the dynamic transaction data 30. The dynamic transaction data 30 is processed through the first hashing function or algorithm 18 to generate hashed dynamic transaction data 32.

The TRM 20 includes TRM input logic 22 that receives secure zero knowledge external static hardware registration signature protocol input 34 and secure zero knowledge internal static hardware registration signature protocol input 36. The external input 34 and the internal input 36 that are input into TRM input logic 22 may be stored on hardware in the TRM 20. The external input 34 is a sufficiently random and unclonable static hardware registration signature. In one particular exemplary embodiment, the secure zero knowledge external static hardware registration signature protocol input 34 is a handwritten signature. In another exemplary embodiment, the secure zero knowledge internal static hardware registration signature protocol input 36 is a PUF response acquired from an exemplary circuit or ECU within the sending device 12. The external input 34 and the internal input 36 are combined in the TRM input logic 22 to create a blackbox signature 38. The blackbox signature 38 is static and stored on hardware on the TRM 20. The blackbox signature 38 is combined with the hashed dynamic transaction data 32 through an exclusive OR (XOR) function 40. The XOR function 40 generates processed dynamic transaction data 42. The processed dynamic transaction data 42 is processed and executed by the second hashing function 24 to generate the sending device output or the dynamic transaction signature, both of which are referred to as the sending device output 44.

In order for the authentication device 14 to authenticate the data from the sending device 12, the sending device output 44 is provided to the authenticating device that has a functional configuration generally similar to that of the sending device 12. Particularly, sending device output 44 is provided to the input logic 16A of authenticating device 14. Additionally, the input logic 16A of authenticating device 14 also receives the dynamic transaction data 30, as indicated by input 46 to input logic 16A. With the input logic 16A on the authenticating device 14, the authenticating device 14 may recreate or repeat the encryption protocol performed on the sending device in a manner similar to that as described above. Thereafter, a comparator or other logic will be used to compare the authenticating device output 44A with the sending device output 44 to confirm whether they are the same. Particularly, dynamic transaction data 30 is processed through a first hash function 18A on the authenticating device 14 to generate hashed dynamic transaction data 32A. The external static hardware registration signature protocol input 34 and the internal hardware registration signature protocol input 36 from the sending device 12 are provided to the TRM 20A so that an authenticating device blackbox signature 38A may be generated. The hash dynamic transaction data 32A is processed with an XOR function 40A to generate processed dynamic transaction data 42A. The processed dynamic transaction data 42A is processed with a second hashing function or algorithm 24A to generate authenticating device outputs or dynamic transaction signature reproduction, which are referred to generally as the authenticating device output 44A. Comparator logic is utilized to determine whether the authenticating device output 44A matches the sending device output 44. If they match, then the authenticating device confirms that the sending device 12 was the originator of the dynamic transaction data to be sent to a receiving device.

The protocol of the authenticating device 14 represents that by performing the dual hashing in the authenticating device 14 in the same manner as the sending device 12, the authenticating device 14 is able to determine whether the sending device 12 is the true originator of the dynamic transaction data that needs to be sent to a recipient.

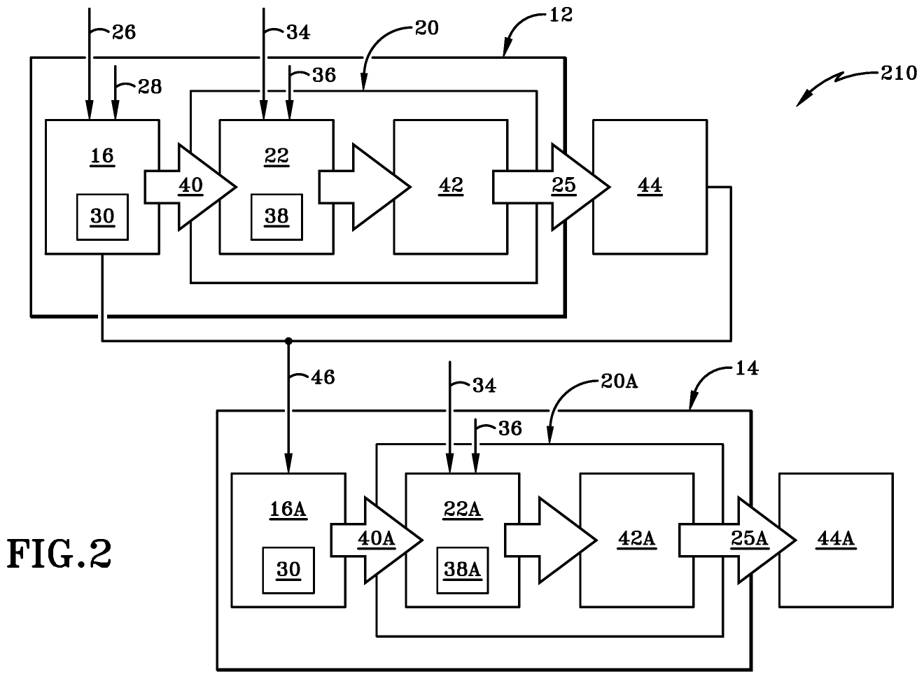

FIG. 2 depicts another exemplary embodiment of an authentication system 210. Authentication system 210 is largely similar to authentication system 110 but removes the first hashing function 18. Thus, in authentication system 210, the dynamic transaction data 30 is processed through an XOR function 40 with the blackbox signature 38 to generate the process dynamic transaction data 42. The process dynamic transaction data 42 goes through a single hashing function or algorithm 25 to create the sending device outputs 44. Outputs 44 are provided as an input 46 to the authenticating device input logic 16A along with the original dynamic transaction data 30. Therein, the authenticating device 14 processes the dynamic transaction data 30 with the blackbox signature 38A through an exclusive OR function 40A to generate the process dynamic transaction data 42A. The process dynamic transaction data 42A is executed through a single hashing function or algorithm 25A to generate the authenticating device outputs 44A. The sending device output 44 is compared with the authenticating device output 44A to determine whether they are the same so that the sending device may transmit its information to a downstream recipient or receiving device.

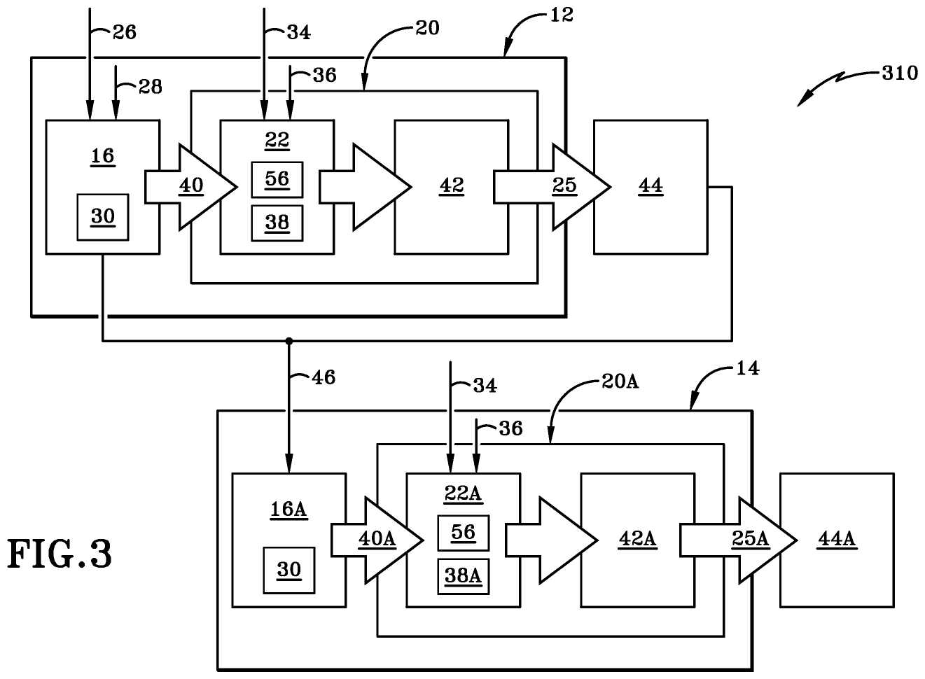

FIG. 3 depicts an authentication system 310 that is largely similar to authenticating system 210 but additionally includes a random number generator 56 (RNG 56) in the TRM input logic 22 to develop the blackbox signature 38. The RNG 56 is used in conjunction with the external input 34 that develops sufficiently random and unclonable static hardware registration signature.

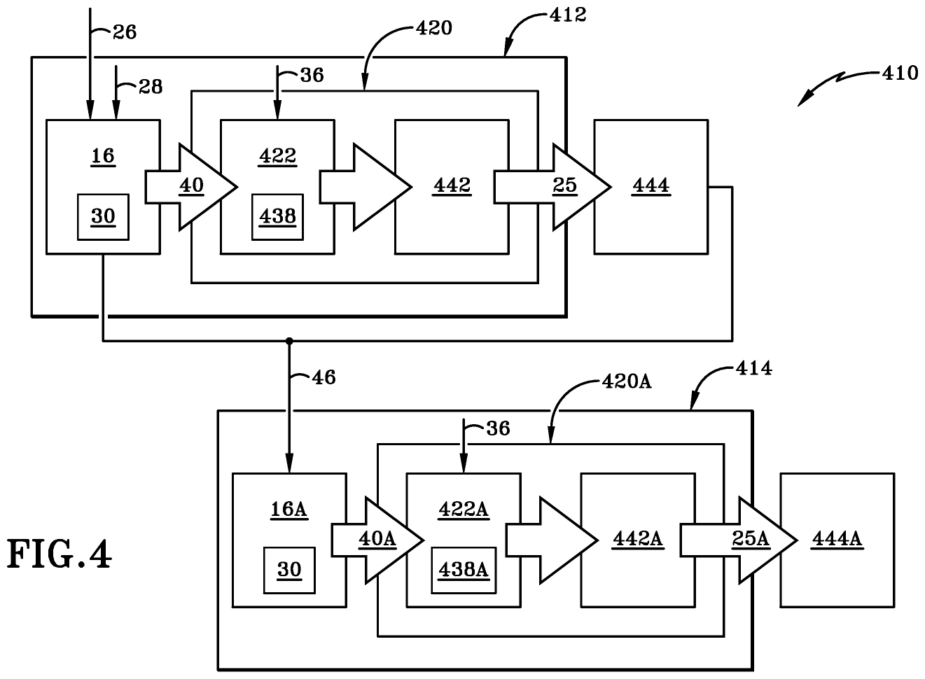

FIG. 4 depicts an authentication system generally at 410. Authentication system 410 includes a sending device 412 and an authenticating device 414 that are in operative communication to determine whether the sending device information desired to be sent to a recipient or recipient device should be authenticated through a PUFDUF protocol that does not require external static hardware registration signature protocol input, previously identified as external static protocol input 34. Sending device 412 includes the input logic 16 with an external input 26 and an internal input 28. These collectively create the dynamic transaction data that may be processed with an XOR function 40 together with the TRM input logic 422 to generate processed dynamic transaction data 442. Authenticating system 410 differs from the previous embodiments inasmuch as it does not require the secure zero knowledge external static hardware registration signature protocol input. The TRM input logic 22 still includes the secure zero knowledge internal static hardware registration signature protocol input 36. The input 36 may be obtained as a PUF signature from an ECU or other circuit contained on the sending device 12. The process dynamic transaction data is processed with at least one hashing function 25 to obtain the sending device output 444.

Within the TRM hardware 420 of authenticating system 410, there is no need for a random number generator inasmuch as the secure zero knowledge internal static hardware registration signature protocol input 36 generates a sufficiently random PUF response from the ECU or circuit on the sending device 412. The TRM 420 utilizes the PUF-based static hardware registration signature to develop the blackbox signature 438 that is processed through the XOR function 40 to obtain the processed dynamic transaction data 442.

The authenticating device 414 utilizes the same PUF-based static hardware registration signature obtained from the secure zero knowledge internal static hardware registration signature protocol input 36 to generate a corresponding blackbox signature 438A in the TRM 420A that is a static signature and stored on hardware. The blackbox signature and the dynamic transaction data 30 are processed through the XOR function 40A to obtain the processed dynamic transaction 442A to obtain the authenticating device output 444A that is then compared with the sending device output 444 to determine if the sending device was properly authenticated.

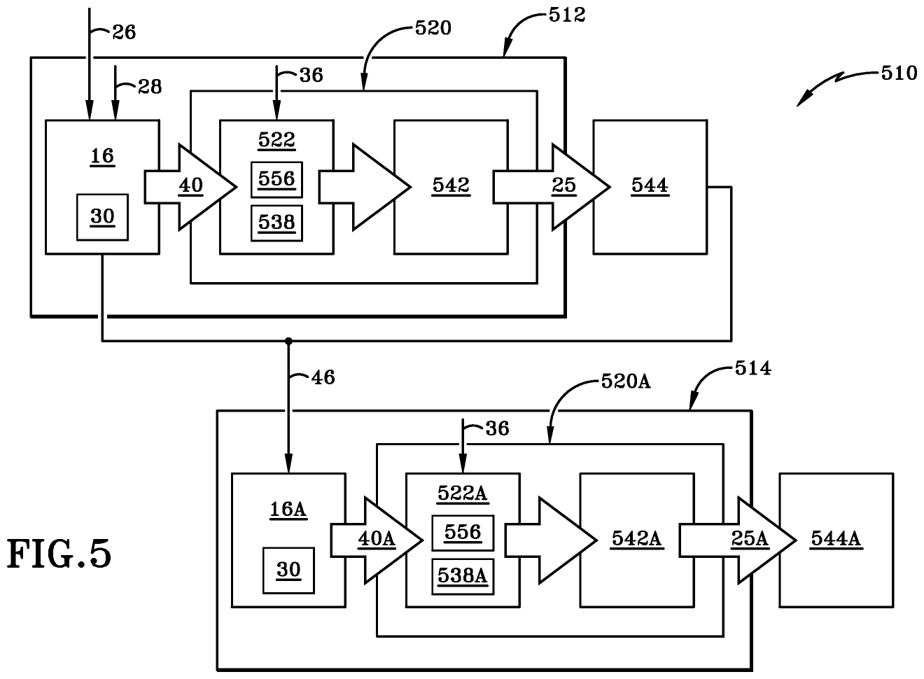

FIG. 5 depicts an authentication system 510 that is largely similar to that of authentication system 410 inasmuch as it does not use the secure zero knowledge external static hardware registration signature protocol input 34, like a handwritten signature, and instead utilizes only the secure zero knowledge internal static hardware registration signature protocol input 36 that is a PUF-based static hardware signature from an ECU or a hardware component on the sending device 512. The TRM input logic 522 in authentication system 510 includes a random number generator 556 to create the blackbox signature 538 that is static or a dynamic signature and stored on hardware. The blackbox signature 538 is processed through an XOR function 40 with dynamic transaction data 30 to result in the processed dynamic transaction data 542. The process dynamic transaction data 542 is processed with a single hashing function or algorithm 25 to obtain the sending device outputs 544. The sending device output 544 is transmitted via input line 46 to the input logic 16A of the authentication device 514. Together, the dynamic transaction data 30 and the sending device output 544 are provided to the authentication device input logic 16A. The authenticating device includes the TRM input logic 522A with the random number generator 556A. The TRM input logic 522A has the same PUF-based static hardware registration signature and obtains a blackbox signature 538A. The blackbox signature 538A may be a static or dynamic signature that is stored on hardware that when processed through the XOR function 40A with the dynamic transaction data 30 results in the processed dynamic transaction data 542A. The process dynamic transaction data 542A is processed with a single or at least one hashing algorithm or function 25A to obtain authenticating device output 544A. Authenticating device output 544A is compared with the sending device output 544 to determine whether the sending device output matches the authentication device output.

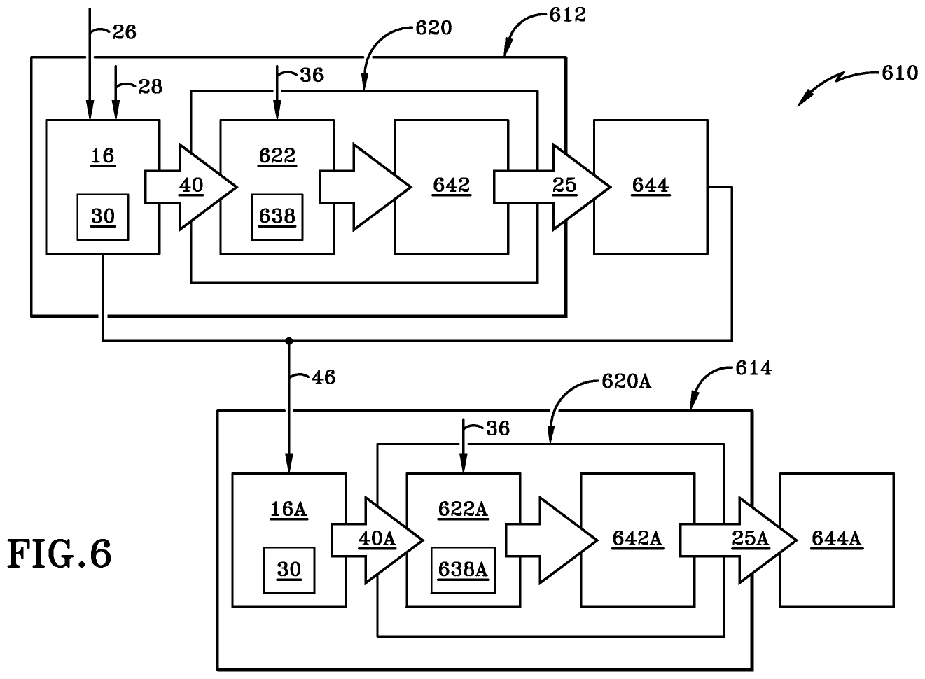

FIG. 6 depicts an authentication system 610 that is largely similar to authentication system 510 except that it eliminates the need for the random number generator. Through the elimination of the random number generator, the TRM input logic 622 utilizes the secure zero knowledge internal dynamic hardware registration signature protocol input 36 to create a multi-PUF based dynamic hardware registration signature. This results in a blackbox signature 638 that is a dynamic multi-signature stored on hardware. The blackbox signature 638 that is a dynamic multi-signature is processed through the XOR function 40 with dynamic transaction data 30 to result in processed dynamic transaction data 642. The process dynamic transaction data 642 is further processed through a single or at least one hashing algorithm or function 25 to obtain the sending device outputs 644. Sending device outputs 644 are transmitted via 46 to the authenticating device input logic 16A along with the original dynamic transaction data 30. The authentication device obtains the same zero knowledge internal dynamic hardware registration signature protocol input 36 without the need of a random number generator to obtain the same multi-PUF based dynamic hardware registration signature. This results in the authenticating device obtaining blackbox signature 638A on the tamper resistant hardware 120. The blackbox signature 638A is processed through the XOR function 40 with the dynamic transaction data 30 to obtain the processed dynamic transaction data 642A. The process dynamic transaction data 642A is processed through the a single or at least one hashing function or algorithm 25A to obtain the authenticating device output 644. Output 644 is then compared with sending device output 44 to determine whether there is a match. If there is a match, then the sending device data can be authenticated for transmission to a recipient.

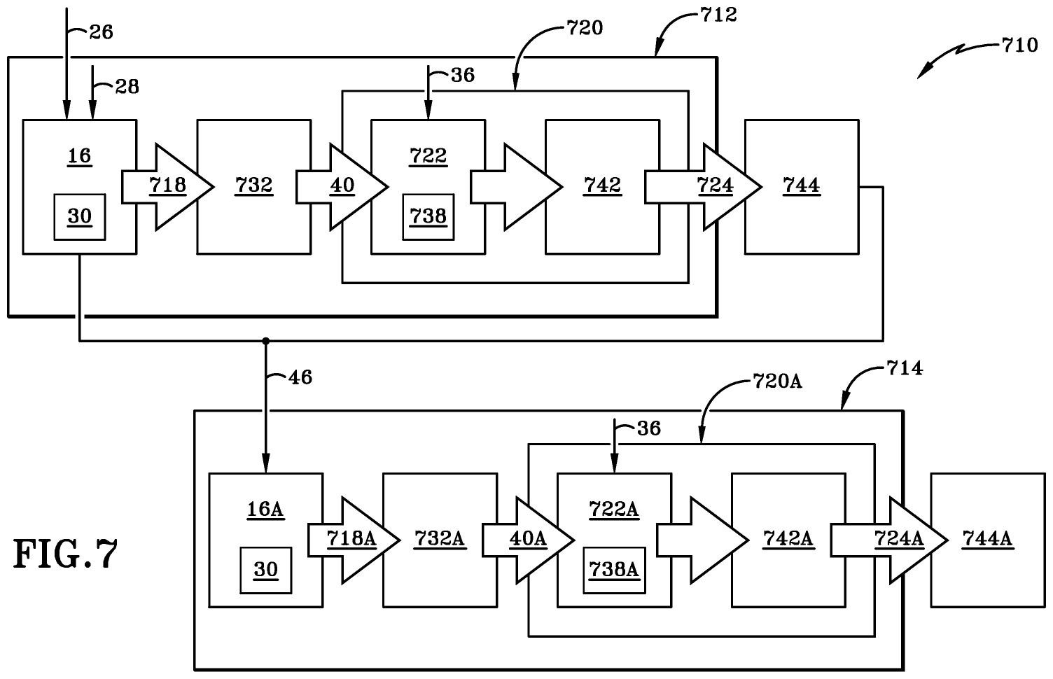

FIG. 7 depicts an authentication system 710 that includes at least two hashing functions in each a sending device 712 and an authentication device 714. The dynamic transaction data 30 is processed through a first hashing function 718 to generate hashed dynamic transaction data 732. One distinction of authenticating system 710 is that it does not require the use of tamper resistant hardware. Rather, the blackbox hardware may be any hardware device or may be fully embodied as software. Thus, the blackbox hardware that is not necessarily tamper resistant hardware is referred to generally as hardware 720 that may include non-tamper resistant software. Hardware 720 only utilizes secure zero knowledge internal dynamic hardware registration signature protocol input 36 which is a PUF-based signature based on an ECU or other microprocessor or computer control unit on the sending device 712. The hardware 720 contains the input logic 722 that uses input 36 to generate the PUF-based dynamic hardware registration signature without the need of any random number generator to obtain the ephemeral blackbox signature 738. The ephemeral blackbox signature 738 is a dynamic multi-signature that does not need to be stored on hardware and can be fully embodied as software, if desired. The ephemeral blackbox signature 738 is processed through the XOR function 40 with the hashed dynamic transaction data 732 to obtain processed dynamic transaction data 742. The process dynamic transaction data 742 is then processed again through a second hashing function or algorithm 724 to provide sending device outputs 744. The sending device outputs 744 are transitioned and provided to the authenticating device via line 60 along with the dynamic transaction data 30. Sending device output 744 and dynamic transaction data 30 are input into the authentication device input logic 716A where the authentication device repeats the PUFDUF protocol of authentication system 710. The first hashing algorithm 718A hashes the dynamic transaction data 30 to obtain hashed dynamic transaction data 732A in authenticating device 14. The secure zero knowledge internal dynamic hardware registration signature protocol input 36 is provided to the hardware on the authenticating device that does not need to be tamper resistant hardware and is just generally referred to as hardware 720A. Hardware 720A utilizes the input 36 to obtain a PUF-based dynamic hardware registration signature without the need of a random number generator. This results in an ephemeral blackbox signature 738A that is a dynamic multi-signature not stored on hardware. The hashed dynamic transaction data 732A is processed through an XOR function with the ephemeral blackbox signature 738A to obtain the processed dynamic transaction data 742A. The processed dynamic transaction data is hashed through a second hashing algorithm or function 724A to produce authentication device outputs 744A. If the authentication device output 744A is compared through a comparator or other comparison logic to determine whether the sending device output 744 matches the authenticating device output 744A, and the comparator determines that there is, in fact, a match, then logic of authentication system 710 may determine that the sending device has the authenticity to send the data to the desired recipient.

For each of these embodiments, with respect to the user id and/or the transaction data, the user has a unique log in identification and the transaction data is associated therewith. For example, if a command was attempting to be sent to a drone, a user log in would be entered and a command would be given to the drone such as turn in a certain direction. These sending device inputs are hashed through the first hashing algorithm or message digest function (MDF). Particularly, one exemplary MDF is the SHA256 function. However, there are other hashing algorithms available, for example, SHA512. Generally, a MDF is a function that works one way but not the other. Namely, the hashing function produces an output but does not allow the output to be recreated through a reversal process.

With respect to the unclonable aspect of the present disclosure, the signature of an external input 34, when performed by a human operator, is not scalable for large or voluminous transactions. The present disclosure addresses the need for creating large scale secure transactions without the need of a human to create an unclonable event. The embodiments discussed herein replace a human unclonable signature with a sufficiently random event, like a human signature, but is fully embodied in computer hardware or software. A PUF is sufficiently random and internal to the device that can replace a human signature and therefore be scalable.

With respect to the embodiments disclosed herein, the sending device outputs and the sending device inputs are both provided via line 46 to the authenticating device input logic. Namely, the user log in identification and the transaction data, as well as the transaction time stamp, are provided to the authenticating device and the sending device outputs are provided to the authentication device input logic. The authentication device then takes the user log in and transaction data and runs through the same protocol that the sending device used to create the sending device output. The goal of which is to recreate the sending device output in the same manner in the authentication device through the use of input logic. Because of the black box hardware, no other devices can produce the output. Since the sending device sent the transaction data and the dynamic log in identification produced through the protocol, the transaction information is used to recreate the hash and then compare the two. If the two outputs match, then the authentication system knows that the information must have come from the authorized sending device because no other device will produce said output.

In embodiments that utilize tamper resistant hardware to effectuate the black box hardware, it is envisioned that the tamper resistant hardware in the sending device is the same as the tamper resistant hardware in the authentication device. However, other scenarios are entirely possible where a first tamper resistant hardware is in the sending device and a different second tamper resistant hardware is in the authenticating device. The tamper resistant hardware protects the black box signature. It is desirable to not have an unauthorized system or personnel to have access to the black box signature. Systems of the present disclosure are attempting to prevent a scenario where another person or system has access to the physical device, they cannot simply place the microchip device in an analyzer to determine what is in the microchip. Essentially, the tamper resistant hardware prevents physical access to the information on the microchip. Whereas, if the black box was an unprotected hard drive, another entity could simply perform an analysis of the hard drive to obtain the black box signature and recreate the protocol.

Each embodiment of the present disclosure may include a registration process to provide the external static protocol input or the internal static protocol input, whichever the case may be per embodiment, onto both the sending device and the authenticating device. The registration process will allow the signature input, regardless of which type or both is used per embodiment, the management of said registration process is performed by managing the process at a secure facility. Namely, both devices are physically present at a secure facility and they are provided with the information simultaneously. However, the registration process may also be performed if both devices are not at a secure facility and the signature process must be done remotely. This scenario would utilize traditional TLS protocols to establish secure communications between internet devices. Other embodiments may utilize a proprietary internet communication system to effectuate the registration process.

### Additional Disclosures

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

As described herein, aspects of the present disclosure may include one or more electrical or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Alternatively, where feasible and/or desirable, various components of the present disclosure may be integrally formed as a single unit.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The term “software” includes “firmware” where appropriate. The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Words used herein in the singular, where the context so permits, shall be deemed to include the plural and vice versa. The definitions of words in the singular herein shall apply to such words when used in the plural where the context so permits and vice versa.

Moreover, the description and illustration of various embodiments of the disclosure are examples and the disclosure is not limited to the exact details shown or described.

1. An authentication system comprising:
a sending device, wherein the sending device includes:
dynamic transaction data;
a first hash function applied to the dynamic transaction data to generate hashed dynamic transaction data;
logic to receive a secure dynamic hardware registration signature protocol, wherein the logic generates an ephemeral signature;
wherein the hashed dynamic transaction data and the ephemeral signature are processed through an exclusive or function (XOR function) to generate processed dynamic transaction data;
a second hash function applied to the processed dynamic transaction data to generate a sending device output;
an authentication device in operative communication with the sending device, wherein the authentication device includes:
inputs for receiving the dynamic transaction data from the sending device and the dynamic transaction signature from the sending device;
an authentication-device first hash function applied to the dynamic transaction data to generate an authentication-device hashed dynamic transaction data in the authentication-device;
logic to receive the secure dynamic hardware registration signature protocol, wherein the logic generates an authentication-device ephemeral signature;
wherein the authentication-device hashed dynamic transaction data and the authentication-device ephemeral signature are processed through another XOR function to generate an authentication-device processed dynamic transaction data;
an authentication-device second hash function applied to the authentication-device processed dynamic transaction data to generate an authentication device output; and
wherein a communication is authenticated if the authentication device output matches the sending device output.

2. A system comprising:
a device and an authentication system
a device identification registered at both the device and the authenticating system; and
a communications network for transmitting data between the device and the authenticating system;
wherein the device and authentication system memories contain the device identification assigned to the device;
wherein the authenticating system authenticates the device for each transaction between the device and the authenticating system by comparing a dynamic login identification created for each transaction in both the device and the authenticating system; and
wherein the dynamic login identification is created at the device and authenticating system by combining the device identification with a login and transaction information to create process data that is processed by a hash algorithm; and
wherein the authentication system memory contains the device identification prior to authentication; and
wherein the device identification is created from processing a Physically Unclonable Function (PUF) of a circuit in the device and one of (i) a random number; (ii) a second PUF of a second circuit in the device; and (iii) the PUF alone, the same device identification is used to create the dynamic login identification for each transaction without the need for a human-based authenticator.

3. The system of claim 2, wherein the device is one of a plurality of devices that are authenticated at a single time without input of the a human-based authenticator.

4. The system of claim 2, wherein the device is a vehicle from a plurality of vehicles receiving a firmware-over-the-air (FOTA) update from a manufacturer of the device, and the circuit generating the PUF identifier is located on the vehicle.

5. The system of claim 2, wherein the device is selected from a group consisting of smart phones, computer laptops, computer tablets, point of sale devices and electronic control units.

6. The system of claim 2, wherein the device is an unmanned vehicle control unit and the authenticating system is an unmanned vehicle.

7. The system of claim 2, wherein the device memory resides on a platform selected from a group consisting of a trusted platform module, SmartCard, and SmartChip.

8. The system of claim 2, wherein the system is selected from a group consisting of financial institutions, commercial retailers, military systems, automobile electronics system, medical institutions, government institutions, cloud storage systems, critical infrastructure systems and security systems.

9. The system of claim 8, wherein the military system is an unmanned vehicle control system.

10. The system of claim 3, wherein the login is selected from a group consisting of a username, password and personal identification number.

11. The system of claim 2, wherein the transaction information is selected from a group consisting of time, transaction cost, command, request and location.

12. A method comprising
creating a device identification associated with a device by processing a Physically Unclonable Function (PUF) of a circuit in a device with a generated random number;
storing the device identification on the device and on an authentication system;
initiating a communication by entering a login into the device;
processing the login, the device identification and transaction information on the device to create a dynamic identification;
processing the login, device identification and transaction information on the authentication system to create a confirmation dynamic identification; and
comparing the dynamic identification and confirmation dynamic identification on the authenticating system to authenticate the device simultaneous to an identical process occurring on a second device needing to be authenticated by the authentication system at the same time as the device without any human-based authenticators.

13. The method of claim 12, wherein the device is selected from a group consisting of smart phones, computer laptops, computer tablets, point of sale devices, unmanned vehicle control units, and electronic control units.

14. The method of claim 12, wherein the device is an unmanned vehicle control unit and the authenticating system is an unmanned vehicle.

15. The method of claim 12, wherein storing the device identification on the device comprises storing the device identification on a platform selected from a group consisting of a trusted platform module, SmartCard, and SmartChip.

16. The method of claim 12, wherein the authentication system is a component of a system selected from a group consisting of financial institutions, commercial retailers, military systems, automobile electronics system, medical institutions, government institutions, cloud storage systems, critical infrastructure systems and security systems.

17. The method of claim 12, wherein the authentication system is an unmanned vehicle control system.

18. The method of claim 12, wherein the login is selected from a group consisting of a username, password and personal identification number.

19. The method of claim 12, wherein the transaction information is selected from a group consisting of time, transaction cost, command, request and location.
